(19) United States
(12) Patent Application Publication
(10) Pub. No.: US 2026/0155107 A1
(43) Pub. Date: Jun. 4, 2026

(54) SCAN DRIVER, DISPLAY DEVICE HAVING THE SCAN DRIVER AND ELECTRONIC DEVICE HAVING THE DISPLAY DEVICE

(71) Applicant: Samsung Display Co., Ltd., YONGIN-SI (KR)

(72) Inventors: KI NYENG KANG, Yongin-si (KR); Chanju Park, Yongin-si (KR); SUNGEUN LEE, Yongin-si (KR); HYOENG-KI KIM, Yongin-si (KR); KEUNKYU SONG, Yongin-si (KR); EONJOO LEE, Yongin-si (KR)

(21) Appl. No.: 19/301,172

(22) Filed: Aug. 15, 2025

(30) Foreign Application Priority Data
Dec. 3, 2024 (KR) 10-2024-0177608

(51) Int. Cl. G09G 3/3266; G09G 3/00; G09G 3/3233

(52) U.S. Cl. CPC G09G 3/3266; G09G 3/035; G09G 3/3233; G09G 2300/0819; G09G 2300/0842; G09G 2300/0861; G09G 2310/0286; G09G 2320/064; G09G 2330/023

(57) ABSTRACT

A scan driver includes a reference scan signal generator configured to generate a plurality of reference scan signals, a first scan signal converter configured to output an N-type scan signal for controlling a conduction state of an N-type transistor based on some of the plurality of reference scan signals, and a second scan signal converter configured to output a P-type scan signal for controlling a conduction state of a P-type transistor based on some of the plurality of reference scan signals.

### CROSS-REFERENCE TO RELATED APPLICATION

This U.S. application claims priority under 35 USC § 119 to Korean Patent Application No. 10-2024-0177608, filed on Dec. 3, 2024, in the Korean Intellectual Property Office, the disclosure of which is incorporated by reference in its entirety herein.

### 1. TECHNICAL FIELD

The present disclosure is directed to a scan driver, a display device having the scan driver and an electronic device having the display device.

### 2. DESCRIPTION OF THE RELATED ART

Modern display devices, such as organic light emitting diode (OLED) and liquid crystal display (LCD) panels, are composed of an array of pixels that serve as the basic units for image generation. Each pixel typically includes a thin-film transistor (TFT) that regulates a driving current in response to a data voltage, thereby controlling the brightness or color output of a light-emitting element. This pixel structure enables high-resolution, high-efficiency visual output in compact form factors, making it useful for contemporary flat-panel and flexible display technologies.

The display devices may display images using a sequential emission method, in which pixels emit light row by row in a defined order, or a simultaneous emission method, in which all pixels emit light at the same time after image data has been sequentially written to each row. However, these display devices often require separate scan driving units to generate corresponding scan signals. This dual-driver approach increases the layout area, complicates routing, and results in greater clock and control signal overhead. Additionally, the separate signal paths can introduce timing mismatches and increase power consumption due to redundant switching activity.

### SUMMARY

An embodiment provides a scan driver and a display device including the same. The problems to be solved by the disclosure are not limited to the problems mentioned above, and other problems and advantages of the disclosure that are not mentioned will be understood by the following description and will be more clearly understood by the embodiments of the disclosure. Further, it will be appreciated that the problems to be solved by the disclosure may be realized by the means and combinations thereof indicated in the claims.

According to an embodiment, a scan driver includes a reference scan signal generator configured to generate a plurality of reference scan signals, a first scan signal converter configured to output an N-type scan signal for controlling a conduction state of an N-type transistor based on some of the plurality of reference scan signals, and a second scan signal converter configured to output a P-type scan signal for controlling a conduction state of a P-type transistor based on some of the plurality of reference scan signals.

In an embodiment, the first scan signal converter may include at least one

NAND gate.

In an embodiment, an N-th reference scan signal and an (N+1)-th reference scan signal, among the plurality of reference scan signals, may be applied to an input terminal of one NAND gate of the at least one NAND gate, and an N-th N-type scan signal may be output to an output terminal of the one NAND gate.

In an embodiment, the second scan signal converter may include at least one NOR gate, and at least one inverter gate respectively connected to the at least one NOR gate.

In an embodiment, an N-th reference scan signal and an (N+1)-th reference scan signal, among the plurality of reference scan signals, may be applied to an input terminal of one NOR gate of the at least one NOR gate, an output terminal of the one NOR gate may be connected to an input terminal of one invert gate of the at least one inverter gate, and an N-th P-type scan signal may be output to an output terminal of the one inverter gate.

In an embodiment, each of the plurality of reference scan signals may include a pulse, and the pulse of each of the plurality of reference scan signals may have a same width.

In an embodiment, a pulse duration of an N-th reference scan signal and a pulse duration of an (N+1)-th reference scan signal, among the plurality of reference scan signals, may partially overlap each other to define an overlapped pulse duration.

In an embodiment, a width of a pulse of the N-type scan signal may be determined based on the width of the pulse of each of the plurality of reference scan signals and a width corresponding to the overlapped pulse duration.

In an embodiment, a width of a pulse of the P-type scan signal may be determined based on a width corresponding to the overlapped pulse duration.

According to an embodiment, a display device includes a display unit including a plurality of pixels, each connected to a corresponding scan line of a plurality of scan lines, and a scan driver configured to apply a scan signal corresponding to each of the plurality of pixels through the plurality of scan lines, wherein the scan driver includes a reference scan signal generator configured to generate a plurality of reference scan signals, a first scan signal converter configured to output an N-type scan signal for controlling a conduction state of an N-type transistor based on some of the plurality of reference scan signals, and a second scan signal converter configured to output a P-type scan signal for controlling a conduction state of a P-type transistor based on some of the plurality of reference scan signals.

In an embodiment, the first scan signal converter may include at least one NAND gate.

In an embodiment, an N-th reference scan signal and an (N+1)-th reference scan signal, among the plurality of reference scan signals, may be applied to an input terminal of one NAND gate of the at least one NAND gate, and an N-th N-type scan signal may be output to an output terminal of the one NAND gate.

In an embodiment, the second scan signal converter may include at least one NOR gate, and at least one inverter gate respectively connected to the at least one NOR gate.

In an embodiment, an N-th reference scan signal and an (N+1)-th reference scan signal, among the plurality of reference scan signals, may be applied to an input terminal of one NOR gate of the at least one NOR gate, an output terminal of the one NOR gate may be connected to an input terminal of one inverter gate of the at least one inverter gate, and an N-th P-type scan signal may be output to an output terminal of the one inverter gate.

In an embodiment, each of the plurality of reference scan signals may include a pulse, and the pulse of each of the plurality of reference scan signals may have a same width.

In an embodiment, a pulse duration of an N-th reference scan signal and a pulse duration of an (N+1)-th reference scan signal, among the plurality of reference scan signals, may partially overlap each other to define an overlapped pulse duration.

In an embodiment, a width of a pulse of the N-type scan signal may be determined based on the width of the pulse of each of the plurality of reference scan signals and a width corresponding to the overlapped pulse duration.

In an embodiment, a width of a pulse of the P-type scan signal may be determined based on a width corresponding to the overlapped pulse duration.

According to an embodiment, an electronic device is provided that includes a display panel and a scan driver. The display panel includes a plurality of pixels, each pixel comprising an N-type transistor and a P-type transistor. The scan driver is configured to provide scan signals to the plurality of pixels. The scan driver includes: a reference scan signal generator configured to generate a plurality of reference scan signals; a first scan signal converter configured to output an N-type scan signal for controlling a conduction state of the N-type transistor, based on overlapping portions of adjacent reference scan signals; and a second scan signal converter configured to output a P-type scan signal for controlling a conduction state of the P-type transistor, based on the same plurality of adjacent reference scan signals.

In an embodiment, the first scan signal converter is configured to determine a pulse width of the N-type scan signal based on a pulse width of each of the reference scan signals and a temporal overlap between pulse durations of an N-th and an (N+1)-th reference scan signal.

Other aspects, features, and advantages in addition to those described above will become apparent from the following drawings, claims, and detailed description of the disclosure.

### BRIEF DESCRIPTION OF THE DRAWINGS

The above and other aspects and features of certain embodiments of the disclosure will be more apparent from the following description taken in conjunction with the accompanying drawings in which:

FIG. 1 is a block diagram of a display device according to an embodiment;

FIG. 2 is a schematic diagram of a circuit of a pixel according to a comparative embodiment;

FIG. 3 is a diagram of a scan driver according to an embodiment;

FIG. 4 is a timing diagram for explaining N-type scan signals according to an embodiment;

FIG. 5 is a diagram of a structure of a first scan signal converter according to an embodiment;

FIG. 6 is a timing diagram for explaining P-type scan signals according to an embodiment;

FIG. 7 is a diagram of a structure of a second scan signal converter according to an embodiment;

FIG. 8 is a diagram of a reference scan signal generator according to an embodiment;

FIG. 9 is a diagram of a reference scan signal generator according to another embodiment; and

FIG. 10 is a diagram of an electronic device that may include the scan driver or the display device, according an embodiment.

### DETAILED DESCRIPTION

As the disclosure allows for various changes and numerous embodiments,

particular embodiments will be illustrated in the drawings and described in detail in the written description. Effects and features of the disclosure and methods of achieving the same will be apparent with reference to embodiments and drawings described below in detail. The disclosure may, however, be embodied in many different forms and should not be construed as being limited to the embodiments set forth herein.

In the following embodiments, the terms “first,” “second,” and the like are not used in a restrictive sense and are used to distinguish one element from another.

The singular forms as used herein are intended to include the plural forms as well unless the context clearly indicates otherwise.

In the following embodiments, it is to be understood that the terms, such as “including” or “having” are intended to indicate the existence of features or components disclosed in the disclosure, and are not intended to preclude the possibility that one or more other features or elements may exist or may be added.

It will be understood that when a unit, region, or element is referred to as being formed on another unit, region, or element, it can be directly or indirectly formed on the other unit, region, or element. That is, for example, intervening units, regions, or elements may be present.

In the following embodiments, terms such as connect or couple do not necessarily mean a direct and/or fixed connection or coupling of two members, unless the context clearly indicates otherwise, and do not exclude the case where another member is interposed between the two members.

The disclosure will now be described more fully with reference to the accompanying drawings, in which preferred embodiments of the disclosure are shown. Like reference numerals in the drawings denote like elements, and thus their description will not be repeated.

Embodiments of the invention relate to a scan driver for a display device that efficiently generates scan signals for both PMOS and NMOS transistors using a shared architecture to reduce layout area, minimize signal delay, and lower the number of required clock signals. Rather than using separate scan driving units for PMOS and NMOS, which would increase circuit complexity and footprint, the scan driver includes a reference scan signal generator that produces a plurality of reference scan signals, a first scan signal converter that generates NMOS scan signals using NAND logic, and a second scan signal converter that generates PMOS scan signals using NOR gates and inverters. Each scan signal may be derived from overlapping pulse sections of adjacent reference signals, allowing unified timing control and enhanced integration for high-resolution or compact display applications.

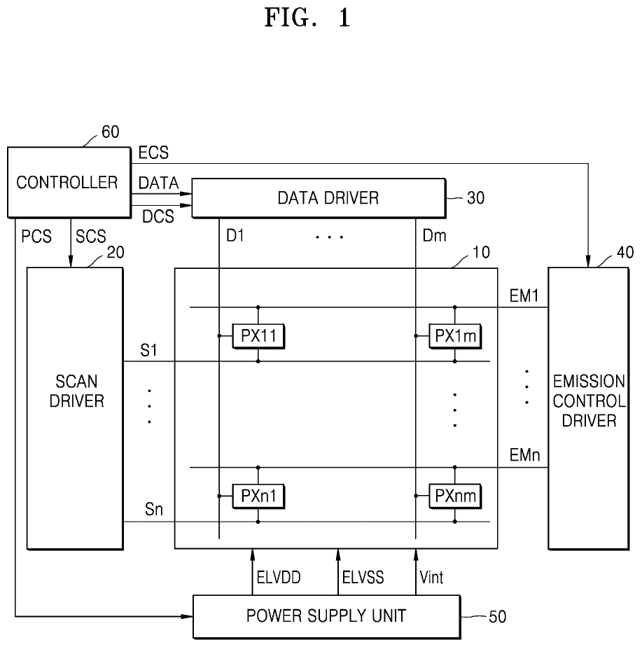

FIG. 1 is a block diagram of a display device according to an embodiment.

Referring to FIG. 1, a display device according to an embodiment may include a display unit 10 including a plurality of pixels PX11 to PXnm, a scan driver 20 (e.g., a first driver circuit), a data driver 30 (e.g., a second driver circuit), an emission control driver 40 (e.g., a third driver circuit), a power supply unit 50 (e.g., a power supply), and a controller 60 (e.g., a controller circuit).

In an embodiment, each of the plurality of pixels PX11 to PXnm may be connected to at least one corresponding scan line among a plurality of scan lines S1 to Sn connected to the display unit 10, at least one corresponding emission control line among a plurality of emission control lines EM1 to EMn, and at least one corresponding data line among a plurality of data lines D1 to Dm.

In an embodiment, each of the plurality of pixels PX11 to PXnm may be connected to a power supply line, which is connected to the display unit 10, to receive a first power voltage ELVDD, a second power voltage ELVSS, and an initialization voltage Vint.

In an embodiment, the display unit 10 may include the plurality of pixels PX11 to PXnm arranged in a certain shape, for example, a matrix shape.

In an embodiment, each of the plurality of pixels PX11 to PXnm may emit light at a certain brightness based on a driving current supplied to its light-emitting element according, wherein the driving current is controlled according to a corresponding data voltage transmitted through the plurality of data lines D1 to Dm.

The display unit 10 may be referred to as a display panel. The display panel may be implemented as one of a liquid crystal display (LCD), a light-emitting diode (LED) display, an organic LED (OLED) display, an active-matrix OLED (AMOLED) display, an electrochromic display (ECD), a digital mirror device (DMD), an actuated mirror device (AMD), a grating light valve (GLV), a plasma display panel (PDP), an electro-luminescent display (ELD), and a vacuum fluorescent display (VFD), and may also be implemented as other types of flat-panel displays or flexible displays.

In an embodiment, the scan driver 20 may generate and transmit scan signals corresponding to respective pixels through the plurality of scan lines S1 to Sn. For example, the scan driver 20 may transmit a scan signal through a corresponding scan line to each of the plurality of pixels included in each row. For example, the scan driver 20 may generate a plurality of scan signals by receiving a scan driving control signal SCS from the controller 60, and sequentially apply the scan signals to the plurality of scan lines S1 to Sn connected to each row.

In an embodiment, the scan driver 20 may generate and apply at least one type of scan signal. As a particular example, the scan driver 20 may generate and supply scan signals required depending on an implementation or emission control method of the pixel, such as a first scan signal GW (e.g., GW[N]), a second scan signal GI (or an initialization scan signal) (GI[N]), a third scan signal GB (or a bypass scan signal) (GB[N]), and a fourth scan signal GC (a compensation scan signal) (e.g., GC[N]). Accordingly, the plurality of scan lines S1 to Sn may include at least one type of scan line, so that a scan line may be configured for each scan signal. In some embodiments, the first scan signal GW may be applied to each of the plurality of pixels PX11 to PXnm through a plurality of first scan lines GWL1 to GWLn, the second scan signal GI may be applied to each of the plurality of pixels PX11 to PXnm through a plurality of second scan lines GIL1 to GILn, the third scan signal GB may be applied to each of the plurality of pixels PX11 to PXnm through a plurality of third scan lines GBL1 to GBLn, and the fourth scan signal GC may be applied to each of the plurality of pixels PX11 to PXnm through a plurality of fourth scan lines GCL1 to GCLn.

In an embodiment, the data driver 30 may transmit a data signal to each pixel through the plurality of data lines D1 to Dm. For example, the data driver 30 may receive a data driving control signal DCS from the controller 60 and apply data signals corresponding to the plurality of data lines D1 to Dm, each of which is connected to a corresponding one of the plurality of pixels PX11 to PXnm in a given row.

In an embodiment, the emission control driver 40 may be connected to the plurality of emission control lines EM1 to EMn connected to the display unit 10, which includes the plurality of pixels PX11 to PXnm arranged in the matrix shape. For example, the plurality of emission control lines EM1 to EMn, which extend almost in parallel to respectively oppose the plurality of pixels in a row direction, may connect each of the plurality of pixels and the emission control driver 40.

In an embodiment, the emission control driver 40 may generate and transmit an emission control signal corresponding to each pixel through the plurality of emission control lines EM1 to EMn. Each pixel that receives an emission control signal may be controlled to emit an image according to an image data signal, in response to the control by the emission control signal. For example, an operation of an emission control transistor included in each pixel may be controlled in response to an emission control signal transmitted through a corresponding emission control line. As a result, a light-emitting element connected to the emission control transistor may either emit or not emit light, and when emitting, its brightness may be determined by a driving current corresponding to a data signal.

In an embodiment, two emission control signals are applied to each pixel. For example, the emission of one pixel may be controlled based on two types of emission control signals.

In an embodiment, the power supply unit 50 may supply the first power voltage ELVDD, the second power voltage ELVSS, the initialization voltage Vint, an anode initialization voltage VAINT or an on-bias voltage VOBS, to each pixel of the display unit 10. For example, the first power voltage ELVDD may be a certain high-level voltage, and the second power voltage ELVSS may be a voltage lower than the first power voltage ELVDD or a ground voltage. For example, the initialization voltage Vint may be set to a voltage value that is equal to or lower than the second power voltage ELVSS.

The voltage values of the first power voltage ELVDD, the second power voltage ELVSS, and the initialization voltage Vint are not particularly limited, and may be set or adjusted under the control of a power control signal PCS transmitted from the controller 60.

In an embodiment, the controller 60 converts a plurality of image signals transmitted from outside into a plurality of image data signals DATA and transmits the plurality of image data signals DATA to the data driver 30. In addition, the controller 60 may receive a vertical synchronization signal Vsync, a horizontal synchronization signal Hsync, and a clock signal MCLK, and may generate and transmit control signals for controlling the driving of the scan driver 20, the emission control driver 40, and the data driver 30, respectively. That is, the controller 60 may generate and transmit a scan driving control signal SCS that controls the scan driver 20, an emission driving control signal ECS that controls an operation of the emission control driver 40, and the data driving control signal DCS that controls the data driver 30. The controller 60 may generate a power control signal PCS that controls an operation of the power supply unit 50 and transmit the generated power control signal PCS to the power supply unit 50.

In an embodiment, the display device may further include a reference voltage generator. For example, the reference voltage generator may generate a reference voltage VRef based on a control signal received from the controller 60. The reference voltage generator may apply the reference voltage VRef to the data driver 30. The reference voltage VRef may have a value corresponding to each data signal DATA. The reference voltage generator may be located inside the controller 60 or inside the data driver 30.

In an embodiment, the data driver 30 may receive the data driving control signal DCS from the controller 60, and may receive the reference voltage VRef from the reference voltage generator. The data driver 30 may convert the data signal DATA into an analog data voltage VDATA using the reference voltage VRef. For example, the data driver 30 may output the data voltage VDATA to a data line.

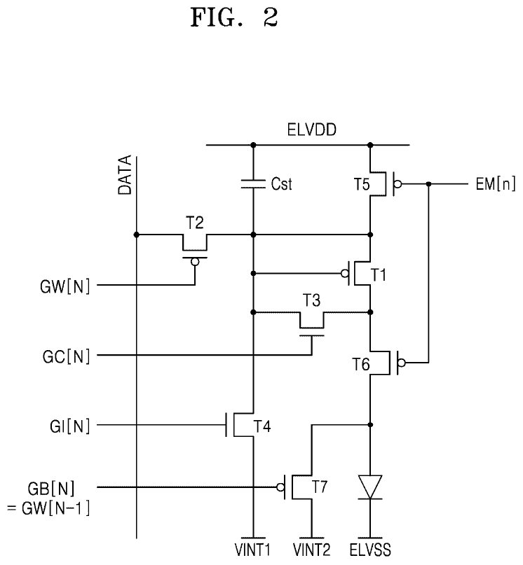

FIG. 2 is a schematic diagram of a circuit of a pixel according to a comparative embodiment.

Referring to FIG. 2, a pixel may include a plurality of transistors, at least one capacitor, and a light-emitting diode. In an embodiment, the plurality of transistors may include a first transistor T1, a second transistor T2, a third transistor T3, a fourth transistor T4, a fifth transistor T5, a sixth transistor T6, and a seventh transistor T7, and the at least one capacitor may include a storage capacitor Cst. An emission signal EM[n] may be supplied to gates of the fifth transistor T5 and the sixth transistor T6.

The first transistor T1 may be referred to as a driving transistor and may generate a driving current based on a voltage applied to electrodes of the first transistor T1. A first electrode (e.g., a source electrode) of the first transistor T1 may be connected to a first node, a second electrode (e.g., a drain electrode) of the first transistor T1 may be connected to a second node, and a third electrode (e.g., a gate electrode) of the first transistor T1 may be connected to a third node. The first transistor T1 may generate a driving current based on a voltage between the third node and the first node.

The second transistor T2 may be connected between a data line that transmits the data signal DATA and the first node, and may be turned on based on a signal applied through a first scan line. A first electrode (e.g., a source electrode) of the second transistor T2 may be connected to a data line, a second electrode (e.g., a drain electrode) of the second transistor T2 may be connected to the first node, and a third electrode (e.g., a gate electrode) of the second transistor T2 may be connected to the first scan line. The second transistor T2 may write the data signal DATA to the first node in response to a first scan signal GW applied through the first scan line. The second transistor T2 may be referred to as a writing transistor.

The third transistor T3 may be connected between the second node and the third node and may be turned on based on a signal applied through a fourth scan line. A first electrode (e.g., a drain electrode) of the third transistor T3 may be connected to the second node, a second electrode (e.g., a source electrode) of the third transistor T3 may be connected to the third node, and a third electrode (e.g., a gate electrode) of the third transistor T3 may be connected to the fourth scan line. The third transistor T3 may electrically connect the second electrode and the third electrode of the first transistor T1 in response to a fourth scan signal GC applied through the fourth scan line. The third transistor T3 may be referred to as a compensation transistor.

The fourth transistor T4 may be connected between an initialization line that transmits an initialization voltage VINT1 and the third node, and may be turned on based on a signal applied through a second scan line. A first electrode (e.g., a drain electrode) of the fourth transistor T4 may be connected to the initialization line, a second electrode (e.g., a source electrode) of the fourth transistor T4 may be connected to the third node, and a third electrode (e.g., a gate electrode) of the fourth transistor T4 may be connected to the second scan line. The fourth transistor T4 may initialize the third node using the initialization voltage VINT1, in response to a second scan signal GI applied through the second scan line. The fourth transistor T4 may be referred to as a driving initialization transistor.

The fifth transistor T5 may be connected between a first power line that transmits a first power voltage ELVDD and the first node, and may be turned on based on a signal applied through an emission control line. A first electrode (e.g., a source electrode) of the fifth transistor T5 may be connected to the first power line, a second electrode (e.g., a drain electrode) of the fifth transistor T5 may be connected to the first node, and a third electrode (e.g., a gate electrode) of the fifth transistor T5 may be connected to the emission control line. The fifth transistor T5 may electrically connect the first power line and the first node in response to an emission control signal applied through the emission control line.

The sixth transistor T6 may be connected between the second node and the fourth node and may be turned on based on a signal applied through the emission control line. A first electrode (e.g., a source electrode) of the sixth transistor T6 may be connected to the second node, a second electrode (e.g., a drain electrode) of the sixth transistor T6 may be connected to the fourth node, and a third electrode (e.g., a gate electrode) of the sixth transistor T6 may be connected to the emission control line. The sixth transistor T6 may electrically connect the second node and the fourth node in response to the emission control signal applied through the emission control line. Each of the fifth transistor T5 and the sixth transistor T6 may be referred to as an emission control transistor.

The seventh transistor T7 may be connected between the initialization line that transmits the initialization voltage VINT1 and the fourth node, and may be turned on based on a signal applied through a third scan line. A first electrode (e.g., a source electrode) of the seventh transistor T7 may be connected to the initialization line, a second electrode (e.g., a drain electrode) of the seventh transistor T7 may be connected to the fourth node, and a third electrode (e.g., a gate electrode) of the seventh transistor T7 may be connected to the third scan line. The seventh transistor T7 may initialize the fourth node using the initialization voltage VINT1, in response to a third scan signal GB applied through the third scan line. The seventh transistor T7 may be referred to as a diode initialization transistor.

In an embodiment, each of the first transistor T1, the second transistor T2, the fifth transistor T5, the sixth transistor T6, and the seventh transistor T7 may be a P-type transistor (e.g., a P-type metal oxide semiconductor field effect transistor (MOSFET)), and each of the third transistor T3 and the fourth transistor T4 may be an N-type transistor (e.g., an N-type MOSFET). In this embodiment, a turn-on voltage of each of the first transistor T1, the second transistor T2, the fifth transistor T5, the sixth transistor T6, and the seventh transistor T7 may be a low voltage, and a turn-on voltage of each of the third transistor T3 and the fourth transistor T4 may be a high voltage.

In this way, a pixel according to an embodiment may include both a P-type MOSFET and an N-type MOSFET, and may require distinct scan signals to control their switching operations, specifically, a scan signal with a negative pulse to control the ON/OFF operation of the P-type MOSFET, and a scan signal with a positive pulse to control the ON/OFF operation of the N-type MOSFET.

In some embodiments, in FIG. 2, each of the first scan signal GW and the third scan signal GB may be a scan signal having a negative pulse, for example, a P-type scan signal that turns a P-type transistor on and off (i.e., controls a conduction state of the P-type transistor), and each of the second scan signal GI and the fourth scan signal GC may be a scan signal having a positive pulse, for example, an N-type scan signal that turns an N-type transistor on and off (.e., controls a conduction state of the N-type transistor).

A scan driver according to a comparative embodiment separately includes a unit that generates a scan signal having a negative pulse and a unit that generates a scan signal having a positive pulse.

However, a scan driver according to an embodiment of the disclosure may generate a scan signal with a negative pulse and a scan signal with a positive pulse without separately including a unit that generates the scan signal with the negative pulse and a unit that generates the scan signal with the positive pulse. Hereinafter, a scan driver according to the disclosure will be described in detail.

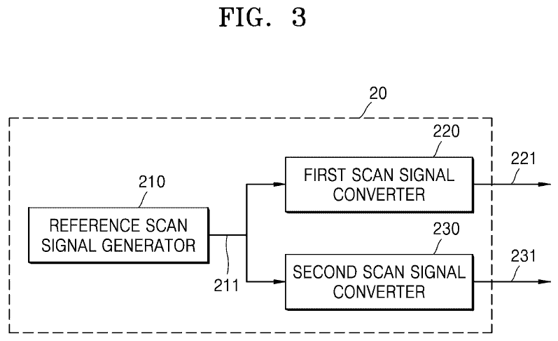

FIG. 3 is a diagram of a scan driver according to an embodiment.

In an embodiment, a scan driver 20 includes a reference scan signal generator 210, a first scan signal converter 220, and a second scan signal converter 230.

In an embodiment, the reference scan signal generator 210 may generate reference scan signals 211. The reference scan signal generator 210 may include a plurality of stages, and each of the plurality of stages may output a corresponding reference scan signal 211. For example, an N-th stage of the reference scan signal generator 210 may generate an N-th reference scan signal, and an (N+1)-th stage may generate an (N+1)-th reference scan signal. In an embodiment, the N-th stage may generate the N-th reference scan signal based on an (N−1)-th reference scan signal, and the (N+1)-th stage may generate the (N+1)-th reference scan signal based on the N-th reference scan signal.

In an embodiment, the reference scan signals 211 have negative pulses.

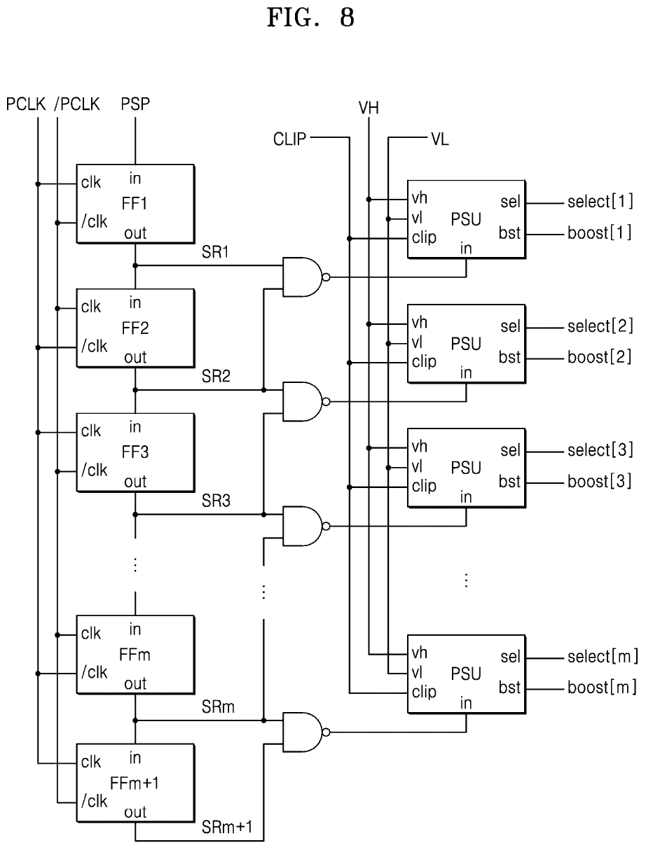

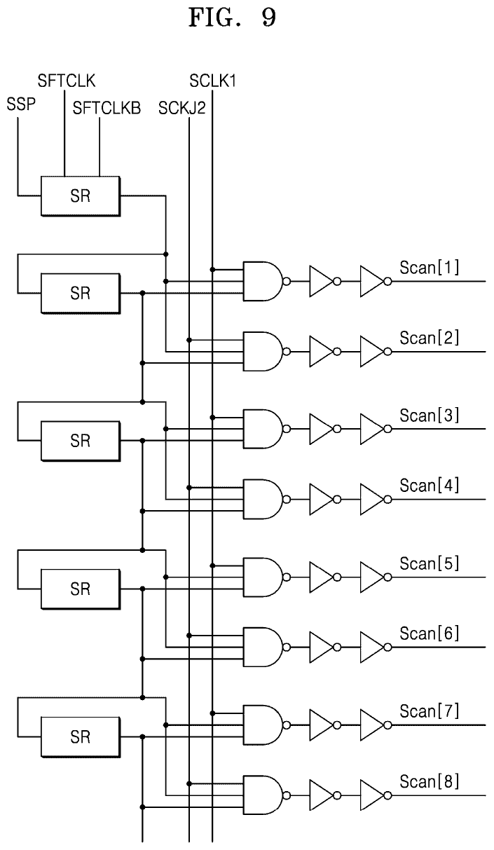

In an embodiment, the reference scan signal generator 210 may include at least one P-type transistor (e.g., P-type MOSFET) and at least one N-type transistor (e.g., N-type MOSFET). However, the disclosure is not limited thereto, and the reference scan signal generator 210 may include only a P-type transistor or may include only an N-type transistor. An embodiment of the reference scan signal generator 210 will be described with reference to FIGS. 8 and 9.

In an embodiment, the first scan signal converter 220 receives the reference scan signals 211, generates first converted scan signals 221 based on the received reference scan signals 211, and outputs the generated first converted scan signals 221. In an embodiment, the second scan signal converter 230 receives the reference scan signals 211, generates second converted scan signals 231 based on the received reference scan signals 211, and outputs the generated second converted scan signals 231.

For example, the first converted scan signals 221 may be N-type scan signals that turn N-type transistors on and off, and the second converted scan signals 231 may be P-type scan signals that turn P-type transistors on and off.

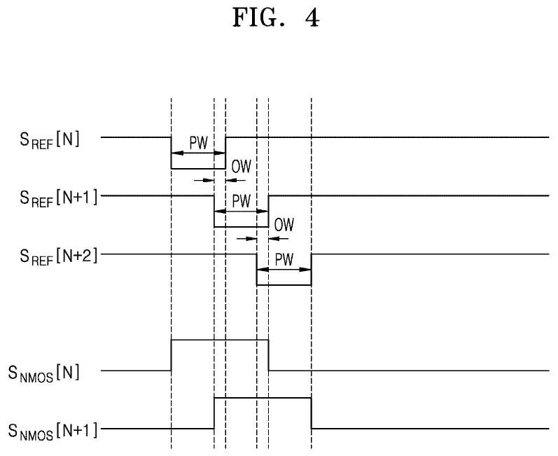

FIG. 4 is a timing diagram for explaining N-type scan signals according to an embodiment.

As described above, N-type scan signals may be generated based on reference scan signals.

FIG. 4 shows a timing diagram of a plurality of reference scan signals, namely, a timing diagram of an N-th reference scan signal S_{REF}[N], an (N+1)-th reference scan signal S_{REF}[N+1], and an (N+2)-th reference scan signal S_{REF}[N+2], and a timing diagram of an N-th N-type scan signal S_{NMOS}[N] and an (N+1)-th N-type scan signal S_{NMOS}[N+1] generated based on the N-th reference scan signal S_{REF}[N], the (N+1)-th reference scan signal S_{REF}[N+1], and the (N+2)-th reference scan signal S_{REF}[N+2].

In an embodiment, the plurality of reference scan signals may include pulses, for example, negative pulses, and the pulses of the plurality of reference scan signals may have the same width. Referring to FIG. 4, the pulse of each of the N-th reference scan signal S_{REF}[N], the (N+1)-th reference scan signal S_{REF}[N+1], and the (N+2)-th reference scan signal S_{REF}[N+2] may have the same width of PW.

Referring to FIG. 4, in an embodiment, the N-th N-type scan signal S_{NMOS}[N] may be transition from a low voltage to a high voltage when the N-th reference scan signal S_{REF}[N] transitions from a high voltage to a low voltage, for example, when the negative pulse of the N-th reference scan signal S_{REF}[N] begins. Likewise, the (N+1)-th N-type scan signal S_{NMOS}[N+1] may transition from a low voltage to a high voltage when the (N+1)-th reference scan signal S_{REF}[N+1] transitions from a high voltage to a low voltage, for example, when the negative pulse of the (N+1)-th reference scan signal S_{REF}[N+1] begins.

Referring to FIG. 4, in an embodiment, the N-th N-type scan signal S_{NMOS}[N] may maintain a high voltage, and then may transition from the high voltage to a low voltage when the (N+1)-th reference scan signal S_{REF}[N+1] transitions from a low voltage to a high voltage, for example, when the negative pulse of the (N+1)-th reference scan signal S_{REF}[N+1] ends. Likewise, the (N+1)-th N-type scan signal S_{NMOS}[N+1] may maintain a high voltage, and then may transition from the high voltage to a low voltage when the (N+2)-th reference scan signal S_{REF}[N+2] transitions from a low voltage to a high voltage, for example, when the negative pulse of the (N+2)-th reference scan signal S_{REF}[N+2] ends.

In summary, the N-th N-type scan signal S_{NMOS}[N] may have a high voltage during periods when either the N-th reference scan signal S_{REF}[N] or the (N+1)-th reference scan signal S_{REF}[N+1] is a low voltage, and at a low voltage during periods when both the N-th reference scan signal S_{REF}[N] and the (N+1)-th reference scan signal S_{REF}[N+1] are high voltages.

As illustrated in FIG. 4, the N-type scan signals each having the positive pulse may be generated based on the plurality of reference scan signals each having the negative pulse.

In an embodiment, the scan driver according to the disclosure adjusts a width of the N-type scan signal. In an embodiment, a width of a pulse of the N-type scan signal is determined based on a width of a pulse of each of the reference scan signals and a width corresponding to a section where pulse durations of the reference scan signals overlap each other.

In an embodiment, the pulse durations of the reference scan signals partially overlap each other. Referring to FIG. 4, a pulse duration of the N-th reference scan signal S_{REF}[N] and a pulse duration of the (N+1)-th reference scan signal S_{REF}[N+1] may partially overlap each other, and a width corresponding to the overlapped pulse duration may be OW. Likewise, referring to FIG. 4, the pulse duration of the (N+1)-th reference scan signal S_{REF}[N+1] and a pulse duration of the (N+2)-th reference scan signal S_{REF}[N+2] may partially overlap each other, and a width corresponding to the overlapped pulse duration may be OW.

Referring to FIG. 4, as described above, the N-th N-type scan signal S_{NMOS}[N] may maintain a high voltage and may transition from the high voltage to a low voltage when the (N+1)-th reference scan signal S_{REF}[N+1] transitions from a low voltage to a high voltage. Therefore, the pulse width of the N-type scan signal may be determined by subtracting OW (i.e., the duration of the overlapping section between the pulse widths of the reference scan signal) from twice the pulse width of each reference scan signal. For example, the pulse width may be calculated as 2*PW-OW.

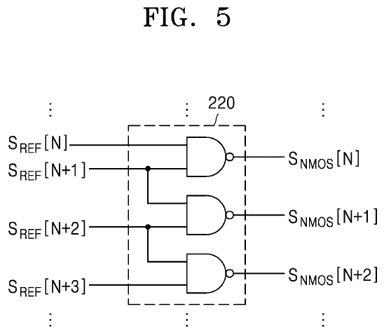

FIG. 5 is a diagram of a structure of a first scan signal converter according to an embodiment.

In an embodiment, the first scan signal converter includes at least one NAND gate. The NAND gate may be a digital logic circuit that outputs a low voltage only when two inputs are all high voltages, and outputs a high voltage otherwise.

In an embodiment, two adjacent reference scan signals may be applied to an input terminal of one NAND gate included in the first scan signal converter 220. Referring to FIG. 5, it is illustrated that the N-th reference scan signal S_{REF}[N] and the (N+1)-th reference scan signal S_{REF}[N+1] are applied to an input terminal of one NAND gate, the (N+1)-th reference scan signal S_{REF}[N+1] and the (N+2)-th reference scan signal S_{REF}[N+2] are applied to an input terminal of another NAND gate, and the (N+2)-th reference scan signal S_{REF}[N+2] and an (N+3)-th reference scan signal S_{REF}[N+3] are applied to an input terminal of still another NAND gate.

In an embodiment, the N-type scan signal may be output to an output terminal of one NAND gate included in the first scan signal converter.

In an embodiment, it is illustrated that the N-th N-type scan signal S_{NMOS}[N] is output to an output terminal of the one NAND gate to which the N-th reference scan signal S_{REF}[N] and the (N+1)-th reference scan signal SREF[N+1]) are input, the (N+1)-th N-type scan signal S_{NMOS}[N+1] is output to an output terminal of the another NAND gate to which the (N+1)-th reference scan signal S_{REF}[N+1] and the (N+2)-th reference scan signal S_{REF}[N+2] are input, and the (N+2)-th N-type scan signal S_{NMOS}[N+2] is output to an output terminal of the still another NAND gate to which the (N+2)-th reference scan signal S_{REF}[N+2] and the (N+3)-th reference scan signal S_{REF}[N+3] are input.

In the embodiment illustrated in FIG. 5, it is illustrated that the N-th N-type scan signal S_{NMOS}[N] is output based on the N-th reference scan signal S_{REF}[N] and the (N+1)-th reference scan signal S_{REF}[N+1], but this is provided as an example, and any suitable N-type scan signal, such as an (N−2)-th, (N+2)-th, or (N+5)-th N-type scan signal, may be output based on the N-th reference scan signal S_{REF}[N] and the (N+1)-th reference scan signal S_{REF}[N+1] for signal timing control.

In an embodiment, the NAND gate may include at least one P-type transistor (e.g., P-type MOSFET) and at least one N-type transistor (e.g., N-type MOSFET). However, the disclosure is not limited thereto, and the NAND gate may be implemented in various manners.

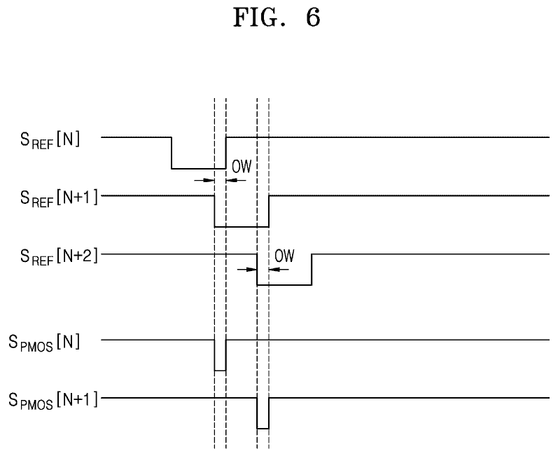

FIG. 6 is a timing diagram for explaining P-type scan signals according to an embodiment.

As described above, P-type scan signals may be generated based on reference scan signals.

FIG. 6 shows a timing diagram of a plurality of reference scan signals, namely, a timing diagram of an N-th reference scan signal S_{REF}[N], an (N+1)-th reference scan signal S_{REF}[N+1], and an (N+2)-th reference scan signal S_{REF}[N+2], and a timing diagram of an N-th P-type scan signal S_{PMOS}[N] and an (N+1)-th P-type scan signal S_{PMOS}[N+1] generated based on the N-th reference scan signal S_{REF}[N], the (N+1)-th reference scan signal S_{REF}[N+1], and the (N+2)-th reference scan signal S_{REF}[N+2].

In an embodiment, the plurality of reference scan signals may include pulses, for example, negative pulses, and the pulses of the plurality of reference scan signals may have the same width. Referring to FIG. 6, the pulse of each of the N-th reference scan signal S_{REF}[N], the (N+1)-th reference scan signal S_{REF}[N+1], and the (N+2)-th reference scan signal S_{REF}[N+2] may have the same width of PW.

Referring to FIG. 6, in an embodiment, the N-th P-type scan signal S_{PMOS}[N] may transition from a high voltage to a lower voltage when the (N+1)-th reference scan signal S_{REF}[N+1] transitions from a high voltage to a low voltage while the N-th reference scan signal S_{REF}[N] maintains a low voltage. Likewise, the (N+1)-th P-type scan signal S_{PMOS}[N+1] may transition from a high voltage to a lower voltage in case that the (N+2)-th reference scan signal S_{REF}[N+2] transitions from a high voltage to a low voltage while the (N+1)-th reference scan signal S_{REF}[N+1] maintains a low voltage.

In summary, the N-th P-type scan signal S_{PMOS}[N] may have a low voltage in a section where both the N-th reference scan signal S_{REF}[N] and the (N+1)-th reference scan signal S_{REF}[N+1] have low voltages.

As illustrated in FIG. 6, the P-type scan signals each having the negative pulse may be generated based on the plurality of reference scan signals each having the negative pulse.

In an embodiment, the scan driver according to the disclosure adjusts a width of a P-type scan signal. In some embodiments, a width of a pulse of the P-type scan signal is determined based on a width corresponding to a section where pulse durations of the reference scan signals overlap each other.

In an embodiment, the pulse durations of the reference scan signals partially overlap each other. Referring to FIG. 6, a pulse duration of the N-th reference scan signal S_{REF}[N] and a pulse duration of the (N+1)-th reference scan signal S_{REF}[N+1] may partially overlap each other, and a width corresponding to the overlapped pulse duration may be OW. Likewise, referring to FIG. 6, the pulse duration of the (N+1)-th reference scan signal S_{REF}[N+1] and a pulse duration of the (N+2)-th reference scan signal S_{REF}[N+2] may partially overlap each other, and a width corresponding to the overlapped pulse duration may be OW.

As described above, the N-th P-type scan signal S_{PMOS}[N] may have a low voltage during a period in which both the N-th reference scan signal S_{REF}[N] and the (N+1)-th reference scan signal S_{REF}[N+1] are at low voltages. This period may correspond to a section where the pulse durations of the N-th reference scan signal S_{REF}[N] and the pulse duration of the (N+1)-th reference scan signal S_{REF}[N+1] partially overlap each other. Accordingly, the width of the pulse of the P-type scan signal may be determined as OW, which is a width corresponding to the section where the pulse durations of the reference scan signals overlap each other.

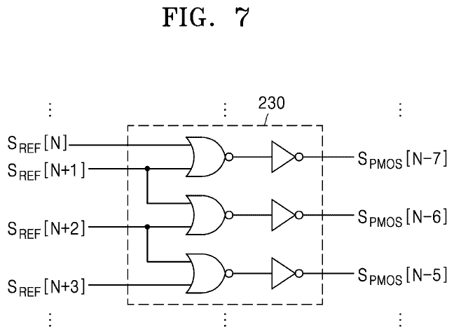

FIG. 7 is a diagram of a structure of a second scan signal converter according to an embodiment.

In an embodiment, the second scan signal converter includes at least one NOR gate. The second scan signal converter may include at least one NOT gate or inverter gate. The NOR gate may be a digital logic circuit that outputs a high voltage only when two inputs are all low voltages, and outputs a low voltage otherwise. The inverter gate may be a digital logic circuit that outputs an opposite value to an input signal, for example, may output a low voltage when an input is a high voltage and a high voltage when an input is a low voltage.

In an embodiment, two adjacent reference scan signals are applied to an input terminal of one NOR gate included in the second scan signal converter. Referring to FIG. 7, it is illustrated that the N-th reference scan signal S_{REF}[N] and the (N+1)-th reference scan signal S_{REF}[N+1] are applied to an input terminal of one NOR gate, the (N+1)-th reference scan signal S_{REF}[N+1] and the (N+2)-th reference scan signal S_{REF}[N+2] are applied to an input terminal of another NOR gate, and the (N+2)-th reference scan signal S_{REF}[N+2] and an (N+3)-th reference scan signal S_{REF}[N+3] are applied to an input terminal of still another NOR gate.

In an embodiment, an input terminal of the inverter gate is connected to an output terminal of the one NOR gate included in the second scan signal converter. In an embodiment, the P-type scan signal is output to an output terminal of the inverter gate.

In an embodiment, it is illustrated that an input terminal of one inverter gate is connected to an output terminal of the one NOR gate to which the N-th reference scan signal S_{REF}[N] and the (N+1)-th reference scan signal S_{REF}[N+1] are input, an (N−7)-th P-type scan signal S_{PMOS}[N−7] is output to an output terminal of the one inverter gate, an input terminal of another inverter gate is connected to an output terminal of the another NOR gate to which the (N+1)-th reference scan signal S_{REF}[N+1] and the (N+2)-th reference scan signal S_{REF}[N+2] are input, an (N−6)-th P-type scan signal S_{PMOS}[N−6] is output to an output terminal of the another inverter gate, an input terminal of still another inverter gate is connected to an output terminal of the still another NOR gate to which the (N+2)-th reference scan signal S_{REF}[N+2] and the (N+3)-th reference scan signal S_{REF}[N+3] are input, and an (N−5)-th P-type scan signal S_{PMOS}[N−5] is output to an output terminal of the still another inverter gate.

In the embodiment illustrated in FIG. 7, it is described that the (N−7)-th P-type scan signal S_{PMOS}[N−7] is output based on the N-th reference scan signal S_{REF}[N] and the (N+1)-th reference scan signal S_{REF}[N+1], but this is provided as an example, and any suitable P-type scan signal, such as an (N−2)-th, N-th, or (N+1)-th P-type scan signal, may be output based on the N-th reference scan signal S_{REF}[N] and the (N+1)-th reference scan signal S_{REF}[N+1] for signal timing control.

In an embodiment, the NOR gate includes at least one P-type transistor (e.g., P-type MOSFET) and at least one N-type transistor (e.g., N-type MOSFET). However, the disclosure is not limited thereto, and the NOR gate may be implemented in various manners.

FIG. 8 is a diagram of a reference scan signal generator according to an embodiment.

The reference scan signal generator shown in FIG. 8 may be understood as an example of the reference scan signal generator 210 described above.

Referring to FIG. 8, a reference scan signal generator according to an embodiment includes at least one flip-flop, at least one level shifter, at least one pulse shaping unit, and at least one NAND gate. For example, the pulse shaping unit may be combinational logic circuits such as NAND and/or NOR gates with inverters. In some embodiments, RC delay network or edge detectors may be combined with these logic circuits to fine-tune the timing.

As described above, the reference scan signal generator may include a plurality of stages, and each of the plurality of stages may output a corresponding reference scan signal. Referring to FIG. 8, the reference scan signal generator may be implemented to output reference scan signals corresponding to the plurality of stages, respectively.

Referring to FIG. 8, the reference scan signal generator may include a plurality of flip-flops, such as FF1, FF2, . . . , FFm, and FFm+1, which are arranged in a sequential chain. Each flip-flop may output a corresponding scan register signal (e.g., SR1, SR2, . . . , SRm, and SRm+1), used as intermediate timing signals for generating reference scan signals.

Each flip-flop may receive clock signals PCLK and /PCLK at its clock terminal to control timing, and the first flip-flop FF1 may receive an input pulse PSP, which initializes or triggers the generation of the first scan register signal SR1. The output SR1 from FF1 may be provided as the input to FF2, whose output is SR2, and this sequential propagation may continue through the remaining flip-flops. In this manner, the scan register signals SR1 through SRm+1 may be generated in a time-staggered fashion based on the clock signals, thereby defining temporal windows suitable for pulse generation.

The scan register signals may be provided to logic gates, such as NAND gates, that receive pairs of adjacent signals (e.g., SR1 and SR2, SR2 and SR3, etc.) and generate intermediate logic outputs. These outputs may be used to define overlapping pulse windows between adjacent scan register signals.

For example, as illustrated in FIG. 8, the output signals SR1 and SR2 from FF1 and FF2, respectively, may be supplied as inputs to a NAND gate, which in turn provides its output to a first pulse shaping unit (PSU). Each PSU may receive additional control signals, such as CLIP (a clamp control signal), VH (a high-level voltage), and VL (a low-level voltage), and may be configured to output shaped signals such as select (e.g., select[1], select[2], select[3], select[m]) and boost (e.g., boost[1], boost[2], boost[3] and boost[m]). These output signals may be used by the scan signal converters to generate final scan signals having desired timing and voltage characteristics.

Through this structure, the reference scan signal generator may produce a plurality of time-shifted reference scan signals derived from clocked flip-flop outputs and shaped by logic and PSU stages. The use of overlapping output intervals from adjacent flip-flops enables precise pulse width control for N-type and P-type scan signals, while minimizing circuit complexity and layout area by reusing a shared reference signal generation chain.

FIG. 9 is a diagram of a reference scan signal generator according to another embodiment.

The reference scan signal generator shown in FIG. 9 may be understood as an example of the reference scan signal generator 210 described above.

Referring to FIG. 9, a reference scan signal generator according to an embodiment includes at least one SR latch, at least one NAND gate, and at least one inverter gate.

As described above, the reference scan signal generator may include a plurality of stages, and each of the plurality of stages may output a corresponding reference scan signal. Referring to FIG. 9, the reference scan signal generator may be implemented to output reference scan signals corresponding to the plurality of stages, respectively.

FIG. 9 illustrates another embodiment of a reference scan signal generator, in which a series of SR stages are connected in a daisy-chained configuration. A first SR stage may receive an initial input signal SSP, along with clock signals SFTCLK and SFTCLKB, to initiate signal propagation. The output of the first SR stage may be provided as an input to the next SR stage, and this pattern continues sequentially through the remaining stages, with each SR stage receiving only the output of its immediate predecessor.

Each SR stage may generate a reference signal used to control the timing of a corresponding scan signal output. As shown in FIG. 9, each scan signal output path may include a three-input NAND gate, a first inverter that receives the output of the NAND gate, and a second inverter that receives the output of the first inverter and generates a scan signal (e.g., Scan[1], Scan[2], Scan[3], Scan[4], Scan[5], Scan[6], Scan[7], and Scan[8]). The NAND gate in each row may receive three inputs: a reference signal output from a corresponding SR stage, and two clock control signals labeled SCKL1 and SCKJ2.

In operation, the output of each SR stage, combined with timing signals SCKL1 and SCKJ2, determines when the corresponding NAND gate will output a low signal. The subsequent inverters shape this output into a scan signal with appropriate logic level and pulse width. This configuration provides a compact and efficient way to generate multiple scan signals from a chain of SR stages, with scan signal timing determined by both the SR signal propagation and the clock control signals. The structure of FIG. 9 thus enables precise timing control while offering a modular and scalable architecture for generating scan signals.

In addition to the examples illustrated in FIGS. 8 and 9, any suitable type of reference scan signal generator which includes a plurality of stages and is capable of outputting reference scan signals corresponding to the respective stages, may be used to implement the scan driver according to the present disclosure.

Although various embodiments of the disclosure have been described as being implemented by the scan driver, these embodiments may also be applied to other drivers.

For example, various embodiments of the disclosure may also be applied to an emission control driver that generates a plurality of emission control signals of a display device. In some embodiments, an emission control driver may include a reference emission control signal generator, a first emission control signal converter, and a second emission control signal converter.

For example, various embodiments of the disclosure may also be applied to a data driver that generates a plurality of data signals of a display device. In some embodiments, the data driver may include a reference data signal generator, a first data signal converter, and a second data signal converter.

According to one or more embodiments of the disclosure, it is not necessary to separately generate scan signals for controlling the ON/OFF states of N-type and P-type transistors, thereby achieving an advantage in terms of layout.

Thus, a pulse width of a scan signal used to control the ON/OFF state of an N-type transistor and that of a scan signal for a P-type transistor may be easily adjusted.

Further, the number of drivers may be decreased, thereby reducing an occurrence of charging and discharging and power consumption.

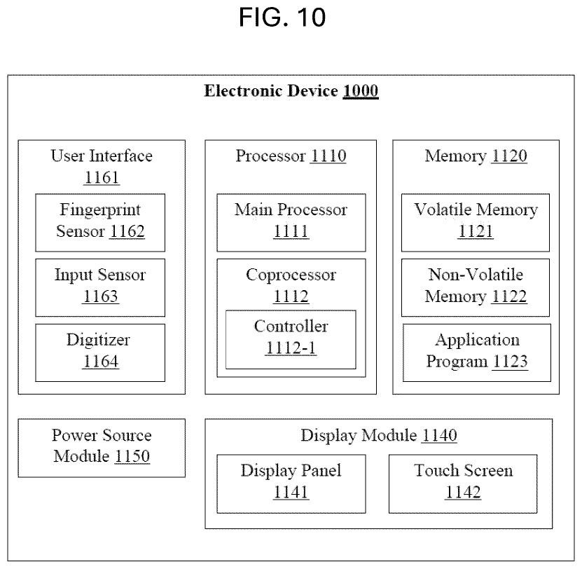

FIG. 10 is a diagram illustrating an electronic device according to an embodiment of the present invention. Referring to FIG. 10, the electronic device 1000 according to one embodiment of the present invention may output various information (e.g., images, text, music, etc.) through a display module 1140, which, for example, may correspond to the display device shown in FIG. 1. When a processor 1110 executes an application stored in a memory 1120, the display module 1140 may provide application information to a user through a display panel 1141.

In some embodiments, the electronic device 1000 may be configured as a smartphone, camera, smart TV, monitor, smartwatch, tablet, automotive display, or AR/VR headset. For example, the electronic device 1000 may be a smartphone including a touch-sensitive display area DA for interaction and a non-display area NDA including sensors and circuits for enhanced functionality. For example, the electronic device 1000 may be a television or monitor including a large display area DA for high-resolution video playback and a non-display area NDA incorporating driving circuits or connectivity modules for external inputs. For example, the electronic device 1000 may be a smartwatch including a display area DA optimized for compact and high-clarity visuals and a non-display area NDA integrating biometric sensors for health monitoring. In some cases, the electronic device 1000 may be an AR/VR headset.

In some embodiments, memory 1120 may store information such as software codes for operating an application program 1123. The application program 1123 may include software designed to execute specific tasks or provide functionality to a user. The application program 1123 may operate under the control of the processor 1110 and utilizes data stored in the memory 1120 to deliver a wide range of features, such as productivity tools, multimedia streaming and playback, file or mail deliveries or communication services. The application program 1123 interacts seamlessly with the user interface 1161 or touch screen 1142, allowing a user to launch, navigate, and utilize the program through user inputs such as touch, tap, gesture, or voice interaction.

Upon user selection of an application via touch screen 1142 or user interface 1161, the processor 1110 may execute the application program 1123 corresponding to the selected application retrieved from the memory 1120 to perform functionalities of the application. For example, when a user selects a camera application by tapping the icon (or a camera application icon) presented on the display panel 1141, the processor 1110 activates a camera module. The processor 1110 may transmit image data corresponding to a captured image acquired through the camera module to the display module 1140. The display module 1140 may display an image corresponding to the captured image through the display panel 1141.

As another example, when a user wishes to make a phone call, the user taps the telephone icon displayed on the display module 1140, the processor 1110 may execute a phone application program stored in the memory 1120. A telephone keypad may be presented on the display panel 1141 for the user to enter a phone number to call.

As another example, the display module 1140 may be integrated into an electronic device 1000, such as a laptop computer, smart TV, or tablet. A user wishing to access a multimedia streaming application (e.g., to watch a music video or movie) can do so by tapping the corresponding icon. This action activates the application, allowing the user to view the streamed content.

The processor 1110 may include a main processor 1111 and an auxiliary or coprocessor 1112. The main processor 1111 may include a central processing unit (CPU). The main processor 1111 may further include one or more of a graphics processing unit (GPU), a communication processor (CP), and an image signal processor (ISP).

The coprocessor 1112 may include a controller 1112-1. The controller 1112-1 may include an interface conversion circuit and a timing control circuit. The controller 1112-1 may receive an image signal from the main processor 1111, convert the data format of the image signal to match the interface specifications with the display module 1140, and output image data. The controller 1112-1 may output various control signals to drive the display module 1140. For example, the controller 1112-1 may drive the display module 1140 to display the icon on the display screen suitable for selection by a user to cause execution of an application program 1123.

The memory 1120 may store one or more application programs 1123 and various data used by at least one component (for example, the processor 1110 or the user interface 1161) of the electronic device 1000 and input data or output data for commands related thereto. For example, a camera application program, a GPS application program, an augmented reality and virtual reality application program, and other application programs that can be executed by the processor 1110 upon selection of corresponding icons presented on the display screen (or display panel 1141) via the touch screen 1142 or user interface 1161 by the user. In addition, various setting data corresponding to user settings may be stored in the memory 1120. The memory 1120 may include volatile memory 1121 and non-volatile memory 1122.

The display module 1140 may output visual information (images) to the user. The display module 1140 may include the display panel 1141, a gate driver, the source driver, a voltage generation circuit, and a touch screen 1142. The display module 1140 may further include a window, a chassis, and a bracket to protect the display panel 1141. The display module 1140 may include at least a part of the configuration of the display device shown in FIG. 1.

The user interface 1161 serves as the interaction medium between a user and the electronic device 1000. The user interface 1161 may detect an input by a part (e.g., finger) of a user's body or an input by a pen or a mouse, and generate an electric signal or data value corresponding to the input. The user interface 1161 includes the fingerprint sensor 1162, the input sensor 1163, and a digitizer 1164.

The fingerprint sensor 1162 may sense a fingerprint for biometric recognition of the user and may also measure one or more biological signals such as blood pressure, moisture, or body mass.

The input sensor 1163 may sense user interactions including touch, tap, gesture, motion, spoken command, and eye movement. The input sensor 1163 includes optical sensors for image capture, eye tracking, or motion and gesture detection. Optical sensors may be infrared or semiconductor photodetectors. The input sensor 1163 includes audio and acoustic sensors, which may be MEMS microphones for voice recognition or sound-based interaction. The audio and acoustic sensors can be installed as part of the user interface 1161 or embedded in the display panel 1141.

The digitizer 1164 may generate a data value corresponding to coordinate information of input by a pen or a mouse to control movement of an onscreen cursor. The digitizer 1164 may generate the amount of change in electromagnetic due to the input as the data value. The digitizer may detect an input by a passive pen or transmit and receive data with an active pen or a remote.

At least one of the fingerprint sensor 1162, the input sensor 1163, or the digitizer 1164 may be implemented as a sensor layer formed on the top layer of the display panel 1141 through a continuous process with a process of forming elements (for example, the light emitting element, the transistor, and the like) included in the display panel 1141.

In addition, the user interface 1161 may further include, for example, a gesture sensor, a gyro sensor that senses rotational movements, an acceleration sensor to track translational movement, a grip sensor, a pressure sensor, a proximity sensor, a color sensor, an infrared (IR) emitter and camera sensor for tracking gaze direction and eye movements, a temperature sensor, or a light sensor. For example, the gyro sensor, acceleration sensor, and infrared emitter and camera may be particularly suitable for AR/VR headset functions.

The touch screen 1142 includes touch sensors embedded in semiconductor layers of the display panel 1141 to sense pressure applied to the top layer (screen) of the display panel 1141. The touch sensors can be a capacitive or a resistive type. The touch screen 1142 may serve as the primary interface for the user to select and navigate applications, control, and interact with the electronic device 1000.

The display panel 1141 (or display) may include a liquid crystal display panel, an organic light emitting display panel, or an inorganic light emitting display panel, and the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141. The display module 1140 may be used to implement the display device 1060. The display panel 1141 may include the display unit shown in FIG. 1.

The power source module 1150 may supply power to the components of the electronic device 1000. The power source module 1150 may be used to implement the power supply 1050. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power source to each of the components described above including the display module 1140.

In addition to the examples described above, various embodiments of the disclosure may be applied to configurations that require for generating both positive and negative pulses.

Each of the embodiments described above may be implemented independently, but the structure of each embodiment may be applied in combination with other embodiments.

As such, the disclosure has been described with reference to the embodiments illustrated in the drawings, but is merely illustrative, and it will be understood by those skilled in the art that various modifications and variations of the embodiments may be made.

In the specification (particularly, in the claims) of the embodiment, the use of the term “the” and similar referential terms may refer to both the singular and the plural. Also, when a range is described in the embodiment, an invention to which individual values belonging to the range are applied is included (unless otherwise described contrarily), and each individual value constituting the range is described in the detailed description. Finally, the steps of the method according to the embodiment may be performed in any suitable order unless otherwise explicitly indicated herein or otherwise clearly contradicted by context. The embodiments are not necessarily limited by the order of steps described above. The use of any examples or illustrative terms in the embodiment is merely to describe the embodiment in detail, and the scope of the embodiment is not limited by the examples or illustrative terms. Further, it will be understood by those skilled in the art that various modifications, combinations and changes may be made depending on design conditions and factors within the scope of the appended claims or their equivalents.

What is claimed is:

1. A scan driver comprising:
a reference scan signal generator configured to generate a plurality of reference scan signals;
a first scan signal converter configured to output an N-type scan signal for controlling a conduction state of an N-type transistor, based on some of the plurality of reference scan signals; and
a second scan signal converter configured to output a P-type scan signal for controlling a conduction state of a P-type transistor, based on some of the plurality of reference scan signals.

2. The scan driver of claim 1, wherein the first scan signal converter comprises at least one NAND gate.

3. The scan driver of claim 2, wherein
an N-th reference scan signal and an (N+1)-th reference scan signal, among the plurality of reference scan signals, are applied to an input terminal of one NAND gate of the at least one NAND gate, and
an N-th N-type scan signal is output to an output terminal of the one NAND gate.

4. The scan driver of claim 1, wherein the second scan signal converter comprises at least one NOR gate, and at least one inverter gate respectively connected to the at least one NOR gate.

5. The scan driver of claim 4, wherein
an N-th reference scan signal and an (N+1)-th reference scan signal, among the plurality of reference scan signals, are applied to an input terminal of one NOR gate of the at least one NOR gate,
an input terminal of one inverter gate of the at least one inverter gate is connected to an output terminal of the one NOR gate, and
an N-th P-type scan signal is output to an output terminal of the one inverter gate.

6. The scan driver of claim 1, wherein
each of the plurality of reference scan signals comprises a pulse, and
the pulse of each of the plurality of reference scan signals has a same width.

7. The scan driver of claim 6, wherein
a pulse duration of an N-th reference scan signal and a pulse duration of an (N+1)-th reference scan signal, among the plurality of reference scan signals, partially overlap each other to define an overlapped pulse duration.

8. The scan driver of claim 7, wherein
a width of a pulse of the N-type scan signal is determined based on the width of the pulse of each of the plurality of reference scan signals and a width corresponding to the overlapped pulse duration.

9. The scan driver of claim 7, wherein
a width of a pulse of the P-type scan signal is determined based on a width corresponding to the overlapped pulse duration.

10. A display device comprising:
a display unit comprising a plurality of pixels, each connected to a corresponding scan line of a plurality of scan lines; and
a scan driver configured to apply a scan signal corresponding to each of the plurality of pixels through the plurality of scan lines,
wherein the scan driver comprises:
a reference scan signal generator configured to generate a plurality of reference scan signals;
a first scan signal converter configured to output an N-type scan signal for controlling a conduction state of an N-type transistor based on some of the plurality of reference scan signals; and
a second scan signal converter configured to output a P-type scan signal for controlling a conduction state of a P-type transistor based on some of the plurality of reference scan signals.

11. The display device of claim 10, wherein the first scan signal converter comprises at least one NAND gate.

12. The display device of claim 11, wherein
an N-th reference scan signal and an (N+1)-th reference scan signal, among the plurality of reference scan signals, are applied to an input terminal of one NAND gate of the at least one NAND gate, and
an N-th N-type scan signal is output to an output terminal of the one NAND gate.

13. The display device of claim 10, wherein
the second scan signal converter
comprises at least one NOR gate, and at least one inverter gate respectively connected to the at least one NOR gate.

14. The display device of claim 13, wherein
an N-th reference scan signal and an (N+1)-th reference scan signal, among the plurality of reference scan signals, are applied to an input terminal of one NOR gate of the at least one NOR gate,
an input terminal of one inverter gate of the at least one inverter gate is connected to an output terminal of the one NOR gate, and
an N-th P-type scan signal is output to an output terminal of the one inverter gate.

15. The display device of claim 10, wherein
each of the plurality of reference scan signals comprises
a pulse, and
the pulse of each of the plurality of reference scan signals has a same width.

16. The display device of claim 15, wherein
a pulse duration of an N-th reference scan signal and a pulse duration of an (N+1)-th reference scan signal, among the plurality of reference scan signals, partially overlap each other to define an overlapped pulse duration.

17. The display device of claim 16, wherein
a width of a pulse of the N-type scan signal is determined based on the width of the pulse of each of the plurality of reference scan signals and a width corresponding to the overlapped pulse duration.

18. The display device of claim 16, wherein
a width of a pulse of the P-type scan signal is determined based on a width corresponding to the overlapped pulse duration.

19. An electronic device comprising:
a display panel including a plurality of pixels, each pixel comprising an N-type transistor and a P-type transistor; and
a scan driver configured to provide scan signals to the plurality of pixels, the scan driver comprising:
a reference scan signal generator configured to generate a plurality of reference scan signals;
a first scan signal converter configured to output an N-type scan signal for controlling a conduction state of the N-type transistor, based on overlapping portions of adjacent reference scan signals; and
a second scan signal converter configured to output a P-type scan signal for controlling a conduction state of the P-type transistor, based on the same plurality of adjacent reference scan signals.

20. The electronic device of claim 19, wherein the first scan signal converter is configured to determine a pulse width of the N-type scan signal based on a pulse width of each of the reference scan signals and a temporal overlap between pulse durations of an N-th and an (N+1)-th reference scan signal.
